(19) United States
(12) Patent Application Publication
(10) Pub. No.: US 2023/0037843 A1
(43) Pub. Date: Feb. 9, 2023

(54) ASSEMBLED BATTERY AND BATTERY PACK

(71) Applicant: Prime Planet Energy & Solutions, Inc., Tokyo (JP)

(72) Inventors: Tomoyuki NAKAMURA, Himeji-shi (JP); Shinya MOTOKAWA, Kasai-shi (JP); Hiroyuki YAMADA, Kasai-shi (JP)

(21) Appl. No.: 17/878,050

(22) Filed: Aug. 1, 2022

(30) Foreign Application Priority Data
Aug. 5, 2021 (JP) 2021-129128

(51) Int. Cl. H01M 10/6572; H01M 10/633; H01M 10/613; H01M 10/6554

(52) U.S. Cl. CPC H01M 10/6572; H01M 10/633; H01M 10/613; H01M 10/6554; H01M 2220/20

(57) ABSTRACT

An assembled battery includes a plurality of Peltier elements, a plurality of control circuits each of which controls an associated one of the plurality of Peltier elements, a plurality of battery cells at least one of which is connected to one end of each of the plurality of Peltier elements, and a heat transfer plate connected to the other end of each of the plurality of Peltier elements.

### CROSS REFERENCE TO RELATED APPLICATIONS

The present application claims priority from Japanese Patent Application No. 2021-129128 filed on Aug. 5, 2021, which is incorporated by reference herein in its entirety.

### BACKGROUND OF THE INVENTION

### Field of the Invention

The present disclosure relates to an assembled battery and a battery pack.

### Description of the Related Art

Conventionally, assembled batteries which include a plurality of battery cells that are assembled have been known. For example, Japanese Laid-open Patent Publication No. 2006-100123 discloses an assembled battery including a plurality of unit batteries and configured such that a unit battery cooling passage is formed between adjacent unit batteries. In the assembled battery, a shutter that can be individually opened and closed is provided at an inlet of each of the unit battery cooling passages. According to Japanese Laid-open Patent Publication No. 2006-100123, circulation of cooling air can be turned on and off by independently opening and closing each shutter, and thus, even when a temperature variation occurs between unit batteries, each of the unit batteries can be individually cooled in accordance with the temperature variation. According to Japanese Laid-open Patent Publication No. 2006-100123, a unit battery in which deterioration has advanced and an internal resistance thereof has been increased has an increased heat generation amount and a life of an entire assembled battery is reduced unless such a unit battery is cooled in an intensive manner.

### SUMMARY OF THE INVENTION

In an assembled battery, a temperature can be equalized between the plurality of battery cells by cooling a battery cell having a high temperature in an intensive manner In the assembled battery, if the temperature is equalized between the plurality of battery cells, an increased life of the assembled battery can be expected and, in addition, high output can be provided. Therefore, an assembled battery of another system in which temperatures of the plurality of battery cells can be equalized is proposed herein. Moreover, a battery pack including a plurality of assembled batteries and configured such that temperatures of the plurality of assembled batteries can be equalized is proposed.

An assembled battery disclosed herein includes a plurality of Peltier elements, a plurality of control circuits each of which controls an associated one of the plurality of Peltier elements, a plurality of battery cells at least one of which is connected to one end of each of the plurality of Peltier elements, and a heat transfer plate connected to the other end of each of the plurality of Peltier elements.

A battery pack disclosed herein includes a plurality of assembled batteries each of which includes a plurality of battery cells that are combined and a first heat transfer plate connected to the plurality of assembled batteries, a plurality of Peltier elements each of which has one end connected to an associated one of the plurality of first heat transfer plates, a plurality of control circuits each of which controls an associated one of the plurality of Peltier elements, and a second heat transfer plate connected to the other end of each of the plurality of Peltier elements.

According to the assembled battery, a heat transfer direction of the plurality of Peltier elements can be controlled by individually driving the plurality of control circuit. Transfer of heat between the battery cells connected to the Peltier elements can be achieved via the heat transfer plate by connecting the plurality of Peltier elements via the heat transfer plate. Thus, temperatures of the plurality of battery cells can be equalized. Similarly, for the battery pack, transfer of heat between the assembled batteries connected to the Peltier elements can be achieved via the second heat transfer plate by controlling a heat transfer direction of the plurality of Peltier elements by individually driving the plurality of control circuits and connecting the plurality of Peltier elements via the second heat transfer plate. Thus, temperatures of the plurality of assembled batteries can be equalized.

The assembled battery may further include a plurality of temperature measuring units each of which corresponds to an associated one of the plurality of Peltier elements and a controller including the plurality of control circuits. Each of the plurality of temperature measuring units measures a temperature of the battery cell connected to the corresponding Peltier element. The controller may include a first processor that acquires each of the temperatures measured by the plurality of temperature measuring units, and a second processor that drives the plurality of control circuits such that a temperature difference between the plurality of temperatures acquired by the first processor is reduced. In the battery pack, each of the plurality of temperature measuring units measures a temperature of the assembled battery connected to the corresponding Peltier element. According to the assembled battery or the battery pack, the temperatures of the plurality of battery cells or the plurality of assembled batteries can be equalized.

In the assembled battery or battery pack, the second processor may include a calculator that calculates an average value of the plurality of temperatures acquired by the first processor, and a driver that drives the plurality of Peltier elements. The driver of the assembled battery may drive the Peltier element connected to the battery cell having a high temperature that is higher than the average value calculated by the calculator by a value exceeding a predetermined temperature such that heat is transferred from the battery cell toward the heat transfer plate and drive the Peltier element connected to the battery cell having a low temperature that is lower than the average value by a value exceeding a predetermined temperature such that heat is transferred from the heat transfer plate toward the battery cell. The driver of the battery pack may drive the Peltier element connected to the assembled battery having a high temperature that is higher than the average value calculated by the calculator by a value exceeding a predetermined temperature such that heat is transferred from the assembled battery toward the second heat transfer plate and drive the Peltier element connected to the assembled battery having a low temperature that is lower than the average value by a value exceeding a predetermined temperature such that heat is transferred from the second heat transfer plate toward the assembled battery.

In the assembled battery including the plurality of temperature measuring units and the controller, the second processor may drive the Peltier element connected to the battery cell having a high temperature that is higher than a preset first temperature such that heat is transferred from the battery cell toward the heat transfer plate and drive the Peltier element connected to the battery cell having a low temperature that is lower than a second temperature that is lower than the first temperature such that heat is transferred from the heat transfer plate toward the battery cell. In the battery pack, the second processor may drive the Peltier element connected to the assembled battery having a high temperature that is higher than a preset first temperature such that heat is transferred from the assembled battery toward the second heat transfer plate and drive the Peltier element connected to the assembled battery having a low temperature that is lower than a second temperature that is lower than the first temperature such that heat is transferred from the second heat transfer plate to the assembled battery. According to the assembled battery or the battery pack, it is possible to suppress an excessive increase and an excessive reduction of the temperatures of the plurality of battery cells or the plurality of assembled batteries. Note that the first temperature and the second temperature in the assembled battery and the first temperature and the second temperature in the battery pack may be the same and may be different.

### BRIEF DESCRIPTION OF THE DRAWINGS

FIG. 1 is a schematic perspective view of an assembled battery according to one preferred embodiment.

FIG. 2 is a flowchart illustrating processes of heat equalization of battery cells.

FIG. 3 is a table illustrating classification of processing in accordance with temperatures of battery cells.

FIG. 4 is a front view of an assembled battery, schematically illustrating an example of transfer of heat between battery cells.

FIG. 5 is a schematic perspective view of a battery pack according to one preferred embodiment.

FIG. 6 is a schematic perspective view of a battery pack configured such that a temperature of each battery cell of an assembled battery is controlled.

### DETAILED DESCRIPTION OF THE PREFERRED EMBODIMENTS

One preferred embodiment of an assembled battery and a battery pack will be described below. As a matter of course, the preferred embodiment described herein is not intended to be particularly limiting the present invention. Each drawing is schematic and does not necessarily reflect an actual product in a faithful manner. In the following description, members/portions that have the same effect are denoted by the same sign and the overlapping description will be omitted or simplified as appropriate.

### [Structure of Assembled Battery]

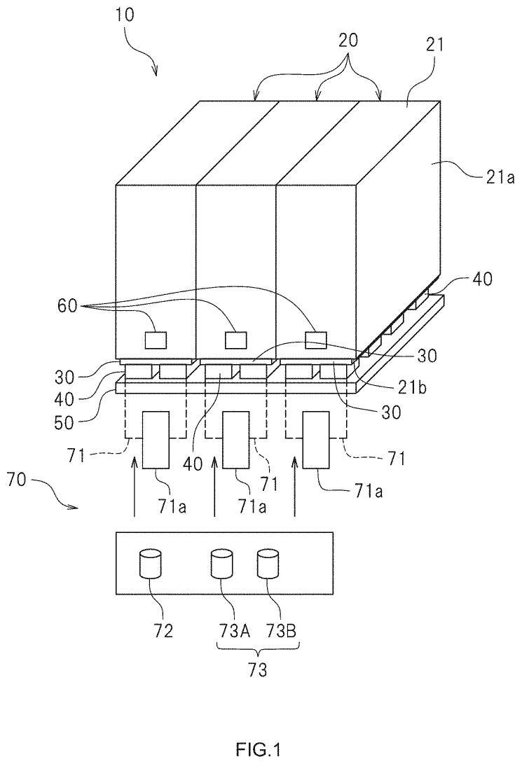

FIG. 1 is a schematic perspective view of an assembled battery 10 according to one preferred embodiment, The assembled battery 10 is a battery including a plurality of battery cells 20 that are assembled. In the assembled battery 10, the plurality of battery cells 20 are connected in series. As illustrated in FIG. 1, the assembled battery 10 according to this preferred embodiment includes a plurality of battery cells 20, a plurality of heat transfer sheets 30, a plurality of Peltier elements 40, a heat transfer plate 50, a plurality of temperature measuring units 60, and a controller 70 that controls the plurality of Peltier elements 40.

The battery cells 20 are rectangular battery cells herein. Each of the battery cells 20 includes a flat rectangular battery case 21 and an electrode body and an electrolytic solution, which are not illustrated, are stored in the battery case 21. The battery cells 20 are herein secondary batteries configured to be capable of charging and discharging. The battery cells 20 are for example, lithium-ion batteries. However, the battery cells 20 are not limited to either rectangular batteries or secondary batteries. There is no particular limitation on a type of the battery cells 20. As illustrated in FIG, 1. in the assembled battery 10, the plurality of battery cells 20 are arranged side by side such that broad width side surfaces 21a of the flat battery cases 21 are fitted to each other.

A bottom surface 21b of each of the battery cases 21 is contacted by an associated one of the heat transfer sheets 30. The heat transfer sheet 30 has an almost same size as that of the bottom surface 21b of the battery case 21. The heat transfer sheets 30 are formed of, for example, a material, such as an aluminum foil of the like, having excellent heat conductivity.

A surface of each of the heat transfer sheets 30 in an opposite side to that of a surface thereof contacting the battery case 21 is contacted by an associated one of the Peltier elements 40. As for the battery cells 20, at least one battery cell 20 may be connected to one end of each of the plurality of Peltier elements 40. Herein, one battery cell 20 is connected to one end of each of the plurality of Peltier elements 40. In this embodiment, each of the battery cells 20 is connected to an associated one of the Peltier elements 40 via an associated one of the heat transfer sheets 30 herein. However, each of the battery cells 20 may be connected directly to one end of an associated one of the Peltier elements 40 without the heat transfer sheet 30 interposed therebetween. “Connection” of each of the battery cells 20 with an associated one of the Peltier elements 40 means that heat conduction therebetween is possible and it does not matter whether there is an inclusion, such as the heat transfer sheet 30 or the like, therebetween. Similar applies to “connection” between each of the plurality of Peltier elements 40 and the heat transfer plate 50.

The Peltier elements 40 are semiconductor elements that can transfer heat from one end to the other end by causing a direct current to flow. A heat transfer direction in which heat is transferred by the Peltier elements 40 can be changed by changing a direction of a flow of the direct current. A transfer amount per time achieved by the Peltier elements 40 is not linear in general but varies in accordance with an electric current. As the Peltier element 40, a known Peltier element can be preferably used and there is no particular limitation on the Peltier element 40. One Peltier element 40 may include a group of Peltier elements that are controlled in synchronization. The group of Peltier elements included in the Peltier element 40 may be physically separated or united.

The heat transfer plate 50 is r connected to the other end of each of the plurality of Peltier elements 40 (an end of each of the Peltier elements 40 in an opposite side to that of an end connected to an associated one of the battery cells 20). The number of the heat transfer plates 50 is one for one assembled battery 10. The heat transfer plate 50 is herein a flat plate-shaped member having an almost same area as that of the plurality of battery cells 20 provided to be arranged side by side. The heat transfer plate 50 is formed of a material, such as an aluminum alloy or the like, having excellent heat conductivity. However, there is no particular limitation on a material of the heat transfer plate 50. The heat transfer plate 50 thermally connects the plurality of Peltier elements 40. The heat transfer plate 50 thermally connects the plurality of battery cells 20 via the plurality of Peltier elements 40.

The heat transfer plate 50 also plays a role of a heat radiating plate. Thus, the heat transfer plate 50 may have, for example, a radiator structure that efficiently releases heat. A shape of the heat transfer plate 50 is not limited. Although illustration will be omitted, the assembled battery 10 may include a cooling device (for example, a cooling fan) that cools the heat transfer plate 50 and a heating device (for example, a heater) that heats the heat transfer plate 50.

Each of the plurality of temperature measuring units 60 corresponds to an associated one of the plurality of Peltier elements 40 and measures a temperature of the battery cell 20 connected to the corresponding Peltier element 40. Each of the temperature measuring units 60 includes, for example, a temperature measuring resistor or a thermocouple. However, there is no particular limitation on a configuration of the temperature measuring unit 60. Herein, the temperature measuring unit 60 actually measures the temperature of the corresponding battery cell 20 but the temperatures of some or all of the battery cells 20 may be estimated values estimated from temperatures of the other battery cells 20 or some other indexes.

As illustrated in FIG. 1, the controller 70 incudes a plurality of control circuits 71, a temperature data receiver 72, and a circuit controller 73. The plurality of control circuits 71 control the plurality of Peltier elements 40. Each of the control circuits 71 includes a power source 71a that can switch a direction in which a voltage is applied. The power source 71a is connected to an associated one of the Peltier elements 40. The power source 71a is configured to be capable of selectively causing a direct current in a first direction or a direct current in a second direction that is an opposite direction to the first direction to flow in the corresponding Peltier element 40. The direction in which the voltage of the power source 71a is applied is controlled by the circuit controller 73.

The temperature data receiver 72 is configured to acquire each of temperatures measured by the plurality of temperature measuring units 60, The circuit controller 73 drives the plurality of control circuits 71, based on the plurality of temperatures acquired by the temperature data receiver 72. The circuit controller 73 drives the plurality of control circuits 71 such that a temperature difference between the plurality of temperatures acquired by the temperature data receiver 72 is reduced, and also suppresses excessive increase and reduction of the temperature of each of the battery cells 20 by controlling the control circuits 71.

The circuit controller 73 includes a calculator 73A and a driver 73B. For control in which the temperature difference between the plurality of temperatures acquired by the temperature data receiver 72 is reduced (which will be hereinafter also referred to as “heat equalization control”), the calculator 73A calculates an average value of the plurality of temperatures acquired by the temperature data receiver 72. For the temperature equalization control, the driver 73B drives the Peltier element 40 connected to the battery cell 20 having a high temperature that is higher than the average value calculated by the calculator 73A by a value exceeding a predetermined temperature such that heat is transferred from the battery cell 20 toward the heat transfer plate 50. Thus, the battery cell 20 is cooled and the heat transfer plate 50 is heated, The control of the Peltier elements 40 described above is realized by controlling the direction in which the voltage of the power source 71a of the control circuit 71 is applied.

The driver 73B drives the Peltier element 40 connected to the battery cell 20 having a low temperature that is lower than the average value by a value exceeding a predetermined temperature such that heat is transferred from the heat transfer plate 50 toward the battery cell 20. Thus, the battery cell 20 is heated and the heat transfer plate 50 is cooled. For the battery cell 20 having a temperature that is neither a high temperature that is higher than the average value by a value exceeding the predetermined temperature nor a low temperature that is lower than the average value by a value exceeding the predetermined temperature, heat equalization control is not executed.

The circuit controller 73 controls the temperature of each of the battery cells 20 by controlling the control circuits 71. Such control will be hereinafter also referred to “absolute value control.” In the absolute value control, the circuit controller 73 drives the Peltier element 40 connected to the battery cell 20 having a high temperature that is higher than a preset first temperature such that heat is transferred from the battery cell 20 toward the heat transfer plate 50. Thus, the battery cell 20 having a high temperature that is higher than the first temperature is cooled. The first temperature is a high-temperature side threshold, The circuit controller 73 drives the Peltier element 40 connected to the battery cell 20 having a low temperature that is lower than a second temperature that is lower than the first temperature such that heat is transferred from the heat transfer plate 50 toward the battery cell 20. Thus, the battery cell 20 having a low temperature that is lower than the second temperature is heated. The second temperature is a low-temperature side threshold. In this preferred embodiment, the controller 70 is configured to execute the heat equalization control and the absolute value control in combination.

There is no particular limitation on a configuration of the controller 70. For example, the controller 70 includes a microcomputer. The microcomputer may include, for example, an interface (I/F) that receives data or the like from an external device, a central processing unit (CPU) that executes an instruction of a program, a read only memory (ROM) that stores the program executed by the CPU, a random access memory (RAM) that is used as a working area in which the program is developed, and a storage device, such as a memory or the like, that stores the program or various types of data.

### [Control of Assembled Battery]

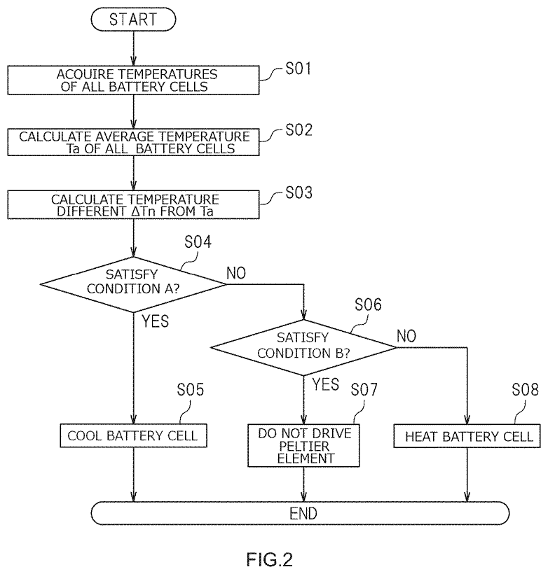

Temperature control of the assembled battery 10 will be described below with reference to a flowchart. FIG. 2 is a flowchart of the temperature control of the assembled battery 10. In FIG. 2, temperature control of the nth battery cell 20 of the plurality of battery cells 20 is illustrated. For the other battery cells 20, similar control is performed thereon and, as a result, temperatures of the assembled battery 10 are controlled. In the following description of the flowchart, the nth battery cell 20 will be occasionally referred to simply as the battery cell 20. The Peltier element 40 corresponding to the nth battery cell 20 will be referred to as an nth Peltier element 40 or also referred to simply as the Peltier element 40.

As illustrated in FIG. 2, in the temperature control of the assembled battery 10, in Step S01, the temperatures of all of the battery cells 20 are acquired from the temperature measuring units 60. In Step S02, an average value Ta of the temperatures of all of the battery cells 20 is calculated. In subsequent Step S03, a temperature difference ΔTn between a temperature Tn of the nth battery cell 20 and the average temperature Ta of all of the battery cells 20 is calculated.

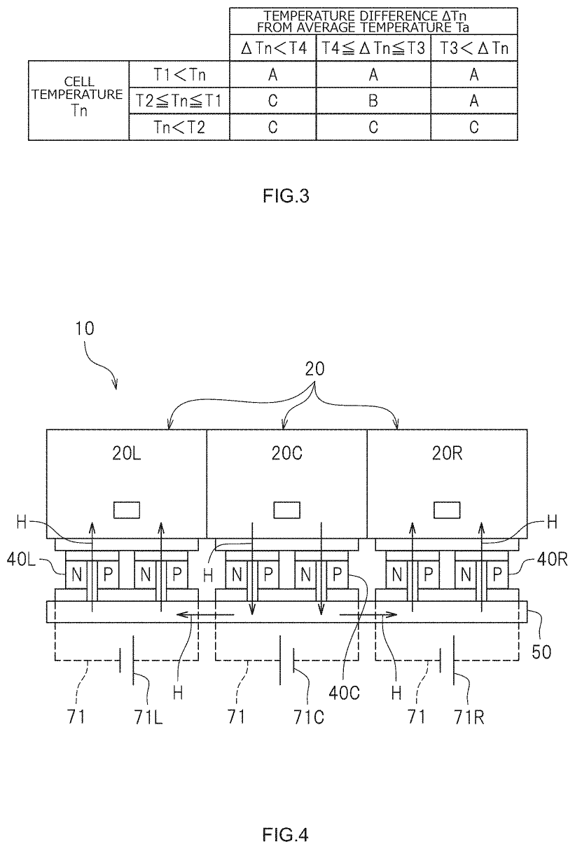

In subsequent Step S04, whether the temperature Tn of the nth battery cell 20 satisfies a condition A illustrated in FIG. 3 is determined. FIG. 3 is a table illustrating classification of processing in accordance with the temperatures of the battery cells 20. As illustrated in FIG. 3, if the temperature Tn of the nth battery cell 20 is higher than a first temperature T1, the temperature Tn satisfies the condition A. Also, when the temperature Tn is a second temperature T2 (that is lower than the first temperature T1) or more and the first temperature T1 or less and the temperature difference ΔTn between the temperature Tn and the average temperature Ta of all of the battery cells 20 is larger than a predetermined allowable temperature difference ΔT3 (ΔT3 is a positive numerical value), the temperature Tn satisfies the condition A. The condition A is satisfied if the temperature Tn of the nth battery cell 20 is too high and if the temperature Tn itself is in an allowable range but is too high as compared to the average temperature Ta of all of the battery cells 20.

As illustrated in FIG. 2, if the temperature Tn satisfies the condition A (if a result of Step S04 is YES), in Step S05, the nth Peltier element 40 is driven such that heat is transferred from the nth battery cell 20 to the heat transfer plate 50. In FIG. 2, this is indicated as “COOL BATTERY CELL.” There is no particular limitation on the first temperature T1, the second temperature T2, and the high-temperature side allowable temperature difference ΔT3. The first temperature T1, the second temperature T2, and the high-temperature side allowable temperature difference ΔT3 are, for example, 40° C., 10° C., and +5° C., respectively.

If the temperature Tn does not satisfy the condition A (if the result of Step S04 is NO), in Step S06, whether the temperature Tn of the nth battery cell 20 satisfies a condition B of FIG. 3 is determined. As illustrated in FIG. 3, when the temperature Tn is the second temperature T2 or more and the first temperature or less and the temperature difference ΔTn is a predetermined low-temperature side allowable temperature difference ΔT4 (ΔT4 is a negative numerical value) or more and the high-side allowable temperature difference ΔT3 or less, the temperature Tn satisfies the condition B. There is no particular limitation on the low-temperature side allowable temperature difference ΔT4. The allowable temperature difference ΔT4 is, for example, −5° C. As illustrated in FIG. 2, if the temperature Tn satisfies the condition B (if a result of Step S06 is YES), in Step S07, the nth Peltier element 40 is not driven. If the temperature Tn of the nth battery cell 20 is in the allowable range and the temperature difference ΔTn from the average temperature Ta of all of the battery cells 20 is in an allowable range, the temperature Tn satisfies the condition B and the nth Peltier element 40 is not driven.

If the temperature Tn does not satisfy the condition B (if the result of Step S06 is NO), the temperature Tn satisfies a condition C. As illustrated in FIG. 3, if the temperature Tn of the nth battery cell 20 is lower than the second temperature T2, the temperature Tn satisfies the condition C. Also, when the temperature Tn is the second temperature T2 or more and the first temperature T1 or less and the temperature difference ΔTn between the temperature Tn and the average temperature Ta of all of the battery cells 20 is smaller than the low-temperature side allowable temperature difference ΔT4, the temperature Tn satisfies the condition C. The condition C is satisfied if the temperature Tn of the nth battery cell 20 is too low and if the temperature Tn itself is in the allowable range but is too low as compared to the average temperature Ta of all of the battery cells 20. In this case, in Step S08, the nth Peltier element 40 is driven such that heat is transferred from the heat transfer plate 50 to the nth battery cell 20. In FIG. 2, this is indicated as “HEAT BATTERY CELL,” The battery cell 20 cannot sufficiently exhibit performance thereof at a low temperature, and therefore, it is preferable that the battery cell 20 is heated if the battery cell 20 has a low temperature. The controller 70 controls the temperature of the assembled battery 10 by repeating control of FIG. 2. Although illustration and description are omitted, the heat transfer plate 50 may be cooled or heated mainly for the absolute value control.

FIG. 4 is a front view of the assembled battery 10, schematically illustrating an example of transfer of heat between the battery cells 20. FIG. 4 illustrates, as an example of transfer of heat between the battery cells 20, a case where a battery cell 20C in center in FIG. 4 satisfies the condition A and left and right battery cells 20L and 20R satisfy the condition C. Transfer of heat is indicated by an arrow H and the directions in which the voltage is applied to the Peltier elements 40 is indicated as directions of power sources 71L, 71C, and 71R. The direction of the power source 71C is, as illustrated in FIG. 4, opposite to those of the power sources 71L and 71R. As illustrated in FIG, 4, heat of the battery cell 20C in center is transferred to the heat transfer plate 50 by the Peltier element 40. Thus, the battery cell 20C in center is cooled. The heat transferred from the battery cell 20C in center to the heat transfer plate 50 is transferred to the left battery cell 20L and the right battery cell 20R by a left Peltier element 40L and a right Peltier element 40. Thus, the left battery cell 20L and the right battery cell 20R are heated. As a result, a temperature difference between the plurality of battery cells 20L, 20C, and 20R is reduced. In a case where absolute control is performed at the same time, each of the temperatures of the plurality of battery cells 20L, 20C, ad 20R approximates to the allowable temperature range (in an example of FIG. 3, a temperature range of the first temperature T1 or more and the second temperature T2 or less).

### [Configuration of Battery Pack]

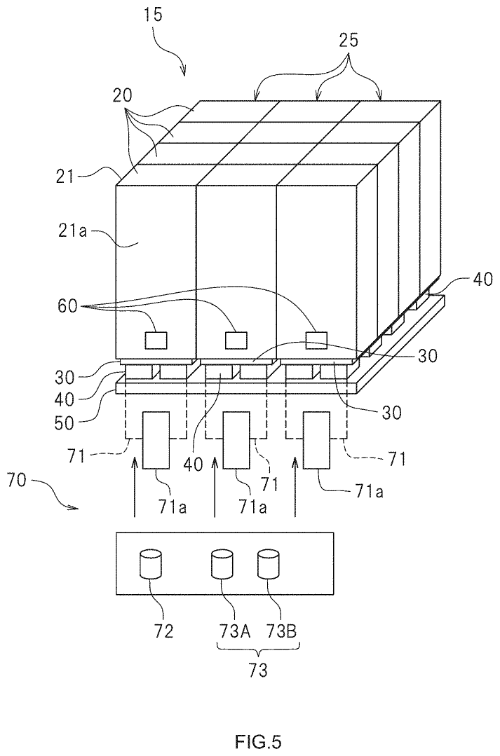

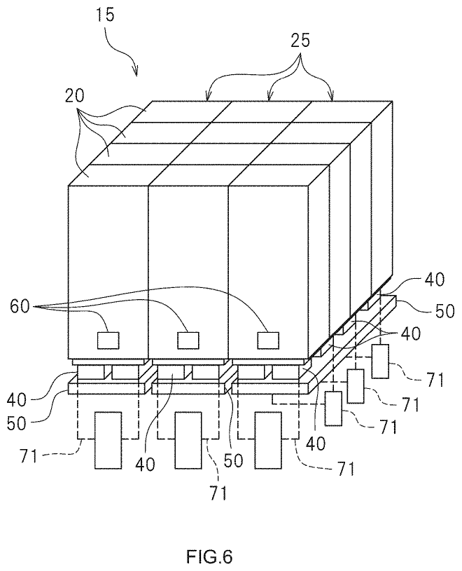

The heat transfer by the Peltier elements 40 described above can be applied to a battery pack including a plurality of assembled batteries that are combined. The battery pack can be used, for example, as an in-vehicle battery pack for a battery electric vehicle or the like. FIG. 5 is a schematic perspective view of a battery pack 15 according to one preferred embodiment. As illustrated in FIG. 5, the battery pack 15 includes a plurality of assembled batteries 25 each of which includes the plurality of battery cells 20 that are combined and the heat transfer sheets 30 connected to the plurality of battery cells 20, the plurality of Peltier elements 40 each of which has one end connected to an associated one of the plurality of heat transfer sheets 30, the heat transfer plate 50 connected to the other end of each of the plurality of Peltier elements 40, the plurality of temperature measuring units 60 each of which measures a temperature of an associated one of the plurality of assembled batteries 25, and the controller 70 that controls each of the Peltier elements 40. The heat transfer sheets 30 is an example of a first heat transfer plate. The heat transfer plate 50 is an example of a second heat transfer plate. In each of the assembled batteries 25, the plurality of battery cells 20 are arranged side by side such that broad width side surfaces 21a of the flat rectangular battery cases 21 are fitted to each other. In the battery pack 15, the plurality of assembled batteries 25 are arranged side by side in a direction orthogonal to a direction in which the battery cells 20 are arranged in each of the assembled batteries 25.

Temperature control of the battery pack 15 is similar to the temperature control of the assembled battery 10 described above. Similar to the assembled battery 10, the controller 70 includes the control circuits 71 each of which controls an associated one of the plurality of Peltier elements 40, the temperature data receiver 72, and the circuit controller 73 including the calculator 73A and the driver 73B. In the temperature control of the battery pack 15, each of the temperature measuring units 60 measures a temperature of the corresponding assembled battery 25. The temperature of the assembled battery 25 may be a temperature (for example, an average temperature or a highest temperature) obtained by performing statistical processing on temperatures measured in a plurality of positions of the assembled battery 25, may be a representative temperature estimated from temperatures measured in a plurality of positions of the assembled battery 25, and may be a temperature of one position of the assembled battery 25. Each of the plurality of Peltier elements 40 corresponds to one assembled battery 25. In this preferred embodiment, a temperature that is a target to be controlled by the Peltier element 40 is a temperature of each of the assembled batteries 25,

However, also in the battery pack 15, the temperature of each of the assembled batteries 25 may be controlled. FIG. 6 is a schematic perspective view of the battery pack 15 configured such that the temperature of each of the battery cells 20 of the assembled batteries 25 is controlled. In the battery pack 15 illustrated in FIG. 6, one Peltier element 40 is connected to each of the plurality of battery cells 20. One Peltier element 40 is controlled by one control circuit 71. Each of the plurality of temperature measuring units 60 measures a temperature of one battery cell 20. The heat transfer plate 50 is provided for each assembled battery 25. The battery pack 15 can be realized by the structure described above.

As described above, the assembled battery 10 according to this preferred embodiment includes the plurality of Peltier elements 40, the plurality of control circuits 71 each of which controls an associated one of the plurality of Peltier elements 40, the plurality of battery cells 20 at least one of which is connected to one end of an associated one of the plurality of Peltier elements 40, and the heat transfer plate 50 connected to the other end of each of the Peltier elements 40. According to the assembled battery 10, the heat transfer direction of the plurality of Peltier elements 40 can be controlled by individually driving the plurality of control circuits 71. Heat can be transferred between the battery cells 20 connected to the Peltier elements 40 via the heat transfer plate 50 by connecting the plurality of Peltier elements 40 to each other via the heat transfer plate 50. Thus, the temperatures of the plurality of battery cells 20 can be equalized. In particular, the temperatures can be quickly equalized between the plurality of battery cells 20 by forcibly transferring heat by the Peltier elements 40. Similarly, for the battery pack 15, the temperatures of plurality of assembled batteries 25 can be more quickly equalized. Thus, a life of the assembled battery 10 or the battery pack 15 can be increased and, in addition, high output can be provided. In a case where a variation between the temperatures of the plurality of battery cells 20 or assembled batteries 25 is large, in consideration of deterioration, an output has to be suppressed using the battery cell 20 or the assembled battery 25 having a highest temperature as a reference. On the other hand, according to the assembled battery 10 or the battery pack 15 according to this preferred embodiment, a variation in the temperature between the plurality of battery cells 20 or assembled batteries 25 can be made small, and therefore, the assembled battery 10 or the battery pack 15 can be used without suppressing the output so much.

The assembled battery 10 according to this preferred embodiment includes a plurality of temperature measuring units 60 each of which corresponds to an associated one of the plurality of Peltier elements 40 and the controller 70 including the plurality of control circuits 71. Each of the plurality of temperature measuring units 60 measures a temperature of the battery cell 20 connected to the corresponding Peltier element 40. The controller 70 includes the temperature data receiver 72 that acquires each of temperatures measured by the plurality of temperature measuring units 60 and the circuit controller 73 that drives the plurality of control circuits 71 such that a temperature difference between the plurality of temperatures acquired by the temperature data receiver 72 is reduced. In the battery pack 15, each of the plurality of temperature measuring units 60 measures a temperature of the assembled battery 25 connected to the corresponding Peltier element 40. According to the assembled battery 10 or the battery pack 15, the temperatures of the plurality of battery cells 20 or the plurality of assembled batteries 25 can be equalized.

Specifically, the circuit controller 73 calculates the average value Ta of the plurality of temperatures acquired by the temperature data receiver 72 by the calculator 73A. Furthermore, the driver 73B of the circuit controller 73 drives the Peltier element 40 connected to the battery cell 20 having a high temperature that is higher than the average value Ta calculated by the calculator 73A by a value exceeding the predetermined temperature ΔT3 such that heat is transferred from the battery cell 20 toward the heat transfer plate 50 and drives the Peltier element 40 connected to the battery cell 20 having a low temperature that is lower than the average value Ta by a value exceeding the predetermined temperature ΔT4 such that heat is transferred from the heat transfer plate 50 toward the battery cell 20 (heat equalization control). In the battery pack 15, the driver 73B drives the Peltier element 40 connected to the assembled battery 25 having a high temperature that is higher than the average value Ta calculated by the calculator 73A by a value exceeding a predetermined temperature (that may be the same as ΔT3 and may be different from ΔT3) such that heat is transferred from the assembled battery 25 toward the heat transfer plate 50 and drives the Peltier element 40 connected to the assembled battery 25 having a low temperature that is lower than the average value Ta by a value exceeding a predetermined temperature (that may be the same as ΔT4 and may be different from ΔT4) such that heat is transferred from the heat transfer plate 50 toward the battery cell 20.

In this preferred embodiment, the driver 73B of the circuit controller 73 drives the Peltier element 40 connected to the battery cell 20 having a high temperature that is higher than the preset first temperature T1 such that heat is transferred from the battery cell 20 toward the heat transfer plate 50 and drives the Peltier element 40 connected to the battery cell 20 having a low temperature that is lower than the second temperature T2 that is lower than the first temperature T1 such that heat is transferred from the heat transfer plate 50 toward the battery cell 20 (absolute value control). In the battery pack 15, the circuit controller 73 drives the Peltier element 40 connected to the assembled battery 25 having a high temperature that is higher than a preset first temperature (that may be the same as T1 and may be different from T1) such that heat is transferred from the assembled battery 25 toward the heat transfer plate 50 and drives the Peltier element 40 connected to the assembled battery 25 having a low temperature that is lower than a second temperature (that may be the same as T2 and may be different from T2) that is lower than the first temperature such that heat is transferred from the heat transfer plate 50 toward the assembled battery 25. According to the assembled battery 10 or the battery pack 15, it is possible to suppress an excessive increase and an excessive reduction of the temperatures of the plurality of battery cells 20 or the plurality of assembled batteries 25.

An assembled battery and a battery pack proposed herein have been described above in various manner. The preferred embodiment of the assembled battery and the battery pack disclosed herein shall not limit the present disclosure, unless specifically stated otherwise.

What is claimed is:

1. An assembled battery comprising:
a plurality of Peltier elements;
a plurality of control circuits each of which controls an associated one of the plurality of Peltier elements;
a plurality of battery cells at least one of which is connected to one end of each of the plurality of Peltier elements; and
a heat transfer plate connected to the other end of each of the plurality of Peltier elements.

2. The assembled battery according to claim 1, further comprising:
a plurality of temperature measuring units each of which corresponds to an associated one of the plurality of Peltier elements; and
a controller including the plurality of control circuits,
wherein each of the plurality of temperature measuring units is configured to measure a temperature of the battery cell connected to the corresponding Peltier element, and
the controller includes
a first processor that acquires each of the temperatures measured by the plurality of temperature measuring units, and
a second processor that drives the plurality of control circuits such that a temperature difference between the plurality of temperatures acquired by the first processor is reduced.

3. The assembled battery according to claim 2,
wherein the second processor includes
a calculator that calculates an average value of the plurality of temperatures acquired by the first processor, and
a driver that drives the Peltier element connected to the battery cell having a high temperature that is higher than the average value calculated by the calculator by a value exceeding a predetermined temperature such that heat is transferred from the battery cell toward the heat transfer plate and drives the Peltier element connected to the battery cell having a low temperature that is lower than the average value by a value exceeding a predetermined temperature such that heat is transferred from the heat transfer plate toward the battery cell.

4. The assembled battery according to claim 2,
wherein the second processor drives the Peltier element connected to the battery cell having a high temperature that is higher than a preset first temperature such that heat is transferred from the battery cell toward the heat transfer plate and drives the Peltier element connected to the battery cell having a low temperature that is lower than a second temperature that is lower than the first temperature such that heat is transferred from the heat transfer plate to the battery cell.

5. A battery pack, comprising:
a plurality of assembled batteries each of which includes a plurality of battery cells that are combined and a first heat transfer plate connected to the plurality of battery cells;
a plurality of Peltier elements each of which has one end connected to an associated one of the plurality of first heat transfer plates;
a plurality of control circuits each of which controls an associated one of the plurality of Peltier elements; and
a second heat transfer plate connected to the other end of each of the plurality of Peltier elements.

6. The battery pack according to claim 5, further comprising:
a plurality of temperature measuring units each of which measures a temperature of an associated one of the plurality of assembled batteries; and
a controller including the plurality of control circuits,
wherein the controller includes
a first processor that acquires each of the temperatures measured by the plurality of temperature measuring units, and
a second processor that drives the plurality of control circuits such that a temperature difference between the plurality of temperatures acquired by the first processor is reduced.

7. The battery back according to claim 6,
wherein the second processor includes
a calculator that calculates an average value of the plurality of temperatures acquired by the first processor, and
a driver that drives the Peltier element connected to the assembled battery having a high temperature that is higher than the average value calculated by the calculator by a value exceeding a predetermined temperature such that heat is transferred from the assembled battery toward the second heat transfer plate and drives the Peltier element connected to the assembled battery having a low temperature that is lower than the average value by a value exceeding a predetermined temperature such that heat is transferred from the second heat transfer plate toward the assembled battery.

8. The battery pack according to claim 6,
wherein the second processor drives the Peltier element connected to the assembled battery having a high temperature that is higher than a preset first temperature such that heat is transferred from the assembled battery toward the second heat transfer plate and drives the Peltier element connected to the assembled battery having a low temperature that is lower than a second temperature that is lower than the first temperature such that heat is transferred from the second heat transfer plate to the assembled battery.
